(19) United States
(12) Patent Application Publication
(10) Pub. No.: US 2017/0082054 A1
(43) Pub. Date: Mar. 23, 2017

(54) METHOD AND DEVICE FOR DIAGNOSING PERFORMANCE OF AN INTERNAL COMBUSTION ENGINE

(71) Applicant: SCANIA CV AB, Södertälje (SE)

(72) Inventors: Ola STENLÄÄS, Södertälje (SE); Mikael NORDIN, Järna (SE)

(21) Appl. No.: 15/312,227

(22) PCT Filed: Jun. 16, 2015
(86) PCT No.: PCT/SE2015/050707

§ 371 Date: Nov. 18, 2016

(30) Foreign Application Priority Data
Jun. 17, 2014 (SE) 1450750-3

(51) Int. Cl. F02D 41/22; G01M 15/08; G01L 23/08; F02D 41/14; F02D 35/02

(52) U.S. Cl. CPC F02D 41/22; F02D 41/1497; F02D 35/023; G01L 23/08; G01M 15/08

(57) ABSTRACT

A method and a device for diagnosis of performance during a combustion process in a combustion chamber in at least one cylinder in a combustion engine. The method comprises the steps: during a working cycle with combustion, detecting movements in a cylinder head belonging to said cylinder or in parts adjacent thereto in the engine, generated at pressure changes arising at the combustion in the combustion chamber, based upon the detected movements, calculating said pressure changes in the combustion chamber, and based upon the calculated pressure changes, determining whether the actual performance differs from the expected performance.

### CROSS-REFERENCE TO RELATED APPLICATION(S)

This application is a national stage application (filed under 35 §U.S.C. 371) of PCT/SE15/050707, filed Jun. 16, 2015 of the same title, which, in turn claims priority to Swedish Application No. 1450750-3, filed Jun. 17, 2014 of the same title; the contents of each of which are hereby incorporated by reference.

### FIELD OF THE INVENTION

The present invention relates to a method and a device to diagnose the performance at a combustion process in a combustion engine and also relates to a computer program product comprising computer program code for the implementation of a method according to the invention, and an electronic control device and a motor vehicle.

### BACKGROUND OF THE INVENTION

There is a constant aspiration to achieve control a combustion engine, in such a manner that fuel used therein is burned in the engine's cylinders, while generating a maximum amount of mechanical operation per fuel mass and a minimum amount of emissions. It is also desirable to always be able to deliver a requested torque with as great a precision as possible. In order to achieve this, it is important to be able to have knowledge of the performance of a combustion engine during the combustion process, in order to, based thereupon, to be able to control the amount of fuel injected into a combustion chamber in the respective cylinders, and the timing of the fuel injection. The performance, which in this case related to how much driving torque that may be obtained from a certain injected amount of fuel, depends on the heat value of the fuel burned in the engine, but also on the engine's efficiency. The latter may be optimized by optimizing the timing of fuel injection.

In SE521752, a method is described for monitoring a combustion process in a combustion engine, in order to discover whether fuel is injected in the combustion engine at the wrong time, that is to say when a crankshaft of the combustion engine is in the wrong position. This information is then used to calibrate an injection element in such a way that fuel is injected at a correct crankshaft position. However, this document only determines differences from the expected performance, related to a wrong time for fuel injection, and not differences resulting from, for example, poor fuel.

### SUMMARY OF THE INVENTION

One objective of the present invention is therefore to provide a way, which is improved in at least some aspect in relation to prior art, of diagnosing differences from an expected performance in a combustion engine. Another objective is to achieve a way of diagnosing differences in performance of a combustion engine, which differences are due not only to fuel being injected at the wrong time, but also to the fact that the quality of the fuel does not meet the expected quality.

These objectives are achieved according to the invention through the device and the method according to the enclosed claims.

In one embodiment, a method is achieved to diagnose performance during a combustion process in a combustion chamber of at least one cylinder in a combustion engine. The method comprises,

during a working cycle with combustion, detecting movements in a cylinder head belonging to said cylinder or in parts adjacent thereto in the engine, generated at pressure changes arising at the combustion in the combustion chamber,

based upon the detected movements, calculating said pressure changes in the combustion chamber,

based upon the calculated pressure changes, determining whether the actual performance differs from the expected performance.

Surprisingly, it has been shown that it is possible to detect, during the combustion process in a cylinder in a combustion engine, movements, which the combustion gives rise to in the cylinder head belonging to the cylinder and in parts adjacent thereto in the engine, and that, through analysis of these movements, it is possible to calculate pressure changes in the combustion chamber. Based upon the calculated pressure changes, it is then possible to determine whether the expected performance is achieved, for example with respect to the heat value of the fuel and the engine's efficiency. It is also possible, based on the detected movements, to detect so-called pre-reactions, that is to say reactions which take place during the time between the fuel injection into the combustion chamber and the start of combustion, and to use these in order to diagnose the engine's performance, in combination with the calculated pressure changes during the combustion process itself. Since the method may be carried out at normal operation of the combustion engine, the diagnosis may be used to provide feedback to the vehicle's control system, and be the basis of control of the combustion process during subsequent working-cycles of the combustion engine. An improved control of the fuel amount supplied to the combustion chamber may thus be achieved, since the fuel amount supplied may be increased, if it turns out that the fuel amount supplied does not give rise to the expected performance. Additionally, an improved control of the timing of fuel injection may be achieved. The innovative method may therefore result in a more even engine operation and a lower fuel consumption, with reduced emissions and cost savings as a consequence.

The movements which may be detected and which are generated by pressure changes in the combustion process may for example be vibrations, noise, i.e. gas movements, various types of shape changes and deformations, such as protrusions and strains, in said cylinder head or in adjacent parts in the engine. These may also be movements in the form of strains in screws in the engine, which are detected, such as screws in main bearings or in connecting rod bearings and in cylinder head bolts. The appearance of such movements depends on pressure changes in the combustion chamber, and may for example be detected by applying strain-sensors on such screws. Since the pressure changes may be detected indirectly outside the combustion chamber itself, advantageously no cylinder pressure sensor needs to be fitted inside the combustion chamber. Accordingly, a more cost effective determination of the gas pressure in the cylinder is obtained, and the disruptions, which a cylinder pressure sensor may give rise to, are avoided.

According to one embodiment of the invention, the method also comprises the step

comparing the calculated pressure changes with stored data relating to the expected pressure changes for the relevant operating condition, and calculating a divergence from these,

so that it is determined, based on the divergence, whether the actual performance differs from the expected performance. The calculated pressure changes are here compared with stored data, which have been determined, for example at a calibration of the engine, during the use of certified fuel with a well-known heat value. A divergence from expected pressure changes indicates that the relevant fuel does not have the same heat value as the certified fuel, which was used at the calibration of the engine, but may also indicate that the engine's efficiency, for some reason, has deteriorated. In this embodiment, it is possible to determine relatively easily whether the performance differs from the expected performance, given that there is access to stored data prepared at a calibration. The divergence from the expected pressure changes may be a divergence in amplitude, and/or a shift of the gas pressure curve along the time axis, that is to say a divergence from an expected point in time and crank angle for the start of combustion, the end of combustion, the duration of combustion and/or the timing when 50% of the supplied fuel has burned.

According to one embodiment of the invention, the method comprises the steps:

comparing the calculated pressure changes with stored data, relating to pressure changes in the combustion chamber at a working cycle without combustion,

based upon said comparison, calculating a heat amount released at the combustion,

comparing the released heat amount with an expected released heat amount and calculating a divergence from this,

so that it is determined, based on the divergence, whether the actual performance differs from the expected performance. Here, the actual released heat amount is calculated based on the development over time of the gas pressure in the combustion chamber during combustion, and the gas pressure during a corresponding part of a working cycle without combustion. This gives a reliable measuring value as to whether the actual performance differs from the expected performance, regardless of whether a divergence is due to poor fuel quality or wrong timing of fuel injection.

According to one embodiment of the invention, the method comprises, based on a said divergence, delivery of a measuring value of the actual performance in relation to the expected performance. This measuring value may be based on a divergence from the expected pressure changes, or a divergence from the expected released heat amount. The measuring value which is delivered may then be used to provide feedback to a control system of the engine, for example by compensating for poor fuel quality by injecting a larger amount of fuel, and thus being able to deliver the expected torque output from the engine.

According to one embodiment of the invention, the method comprises the steps

setting at least one first error criterion, and

determining that the actual performance differs from the expected performance, provided that at least the first error criterion is met.

The error criterion may, for example, be set so that it is met if a said divergence exceeds a determined value. Said divergence may relate to a divergence in the amount of heat or in pressure changes. By setting an error criterion, certain minor divergences may be tolerated and only major divergences may give rise to the error criterion being met and measures being taken. Provided that the error criterion or error criteria are met, an alarm may be issued, which may be used, for example, to control the fuel injection during future working cycles. Based on the alarm, an error signal may also be generated, which indicates that there is an error, for example, to a driver of a vehicle operated by the combustion engine, for example that the fuel used does not have a heat value within the expected tolerances.

According to one embodiment of the invention, the method also comprises determining a timing for start of fuel supply to the combustion chamber, and a timing for start of combustion. In this manner, the delay of ignition may be determined, that is to say the time from the fuel supply to the start of combustion. This may be compared with a setpoint value for a fuel with a known heat value and for a relevant operating condition of the engine. The delay of ignition may thus be used to achieve a more secure diagnosis of a detected divergence in performance. The timing of the start of fuel supply may, in the case of a diesel engine, be obtained by reading a signal from an injector, which is used to inject fuel into the combustion chamber.

According to one embodiment of the invention, wherein the combustion engine comprises a crankshaft arranged to be operated with said combustion process via a piston, the method also comprises the steps:

determining the position of the crankshaft at a point in time for at least one event associated with the combustion process, such as start of combustion, end of combustion and/or 50% of burned fuel,

comparing the crankshaft's determined position at said event with stored data relating to an expected position of the crankshaft at said event,

based on the comparison, determining a cause of the divergence between the actual performance and the expected performance.

In this embodiment, a cause of a determined divergence in performance may be determined by controlling whether the combustion occurs at an optimized crankshaft position and whether the combustion has a desired duration. This embodiment is therefore useful when determining whether a performance, which is worse than expected, is due to the quality of the fuel or to the engine's degree of efficiency. The crankshaft's expected position at the start of combustion, at the end of combustion or at 50% burned fuel may, for example, be determined at a calibration of the engine, when the positions at said events are optimized to achieve the best possible efficiency. Its actual position at said events may, for example, be determined based on the calculated pressure changes in the combustion chamber, combined with a signal from a crankshaft sensor.

According to one embodiment of the invention, the method comprises the steps:

setting a second error criterion in such a manner that it is met, if the difference between the crankshaft's said determined position and the crankshaft's said expected position exceeds a determined value,

provided that the second error criterion is not met, determining that a divergence in performance is due to a heat value of the fuel burned during the combustion process not corresponding with an expected heat value.

The second error criterion is thus set in such a way that it is met, if for example the start of combustion occurs at a crank angle differing from what is desirable, but not if the combustion process occurs at an expected point in time and has an expected duration. In this manner, it may be determined with great accuracy that the fuel's quality is the cause of the expected performance not being achieved, provided that the fuel amount supplied does not differ from what is expected. Corrective measures in the form of a control of the injected fuel amount may thus quickly be taken.

According to one embodiment of the invention, the crankshaft's position is determined by way of detecting movements in said cylinder head or in parts adjacent thereto in the engine, generated by the piston's movements in the cylinder. For example, the piston's turns give rise to vibrations, which propagate to the cylinder head. Thanks to this embodiment, one and the same sensor element may be used to detect movements depending on both pressure changes and crank angle positions. The determination of the crankshaft's position may be carried out completely without any signal from a crankshaft sensor, but also in combination therewith, for increased accuracy.

According to one embodiment of the invention, the timing of at least one event associated with the combustion process is determined, such as the start of combustion, the end of combustion and/or 50% burned fuel, by comparing the calculated pressure changes with stored data relating to pressure changes in the combustion chamber at a working cycle without combustion, and based on the comparison, the timing of said event is determined. The timing of the start of combustion may here be set as the time when the calculated pressure changes start to differ from stored data. In this manner, a timing of the start of combustion may be determined with sufficient accuracy. Similarly, a timing of the end of combustion may be determined. The duration of the combustion may here also be determined, both in time and crank angle.

According to one embodiment of the invention, the timing of at least one event associated with the combustion process, such as the start of combustion, the end of combustion, and/or 50% burned fuel, is determined by comparing a calculated released heat amount with stored data relating to an expected released heat amount, and based upon the comparison the timing of said event is determined. This is an alternative manner of determining, with sufficient accuracy, a timing for the start of combustion and/or the end of combustion and/or the duration of the combustion.

According to one embodiment of the invention, wherein the combustion engine comprises an inlet valve and an exhaust valve, the method also comprises detecting the opening and/or closing of at least one of the inlet valve and/or the exhaust valve. By detecting the opening and closing, the timing of these may be determined and compared with setpoint values. If any of several of the compared points of time differ from the setpoint values, this may be a cause for a divergence in performance. If the timing of the opening and closing of the valves, on the other hand, does not differ from the setpoint values, it is possible that the quality of the fuel has caused the divergence. Advantageously, the detection of the valve opening and/or valve closure may be combined with a determination of the crankshaft's position at various events in the combustion process described above, in order thus to achieve a more secure assessment of the cause of the performance being worse than expected.

The opening and/or closing of valves may, for example, be detected by detecting movements in said cylinder head or in parts adjacent thereto in the engine, generated by the opening and/or closing of the valves. For example, the valves' opening and closing give rise to vibrations, which propagate to the cylinder head. Thanks to this embodiment, one and the same sensor element may be used to detect movements depending on both pressure changes, valve opening, valve closing, and, in relevant cases, crank angle positions.

According to one embodiment of the invention, the detection of the pressure changes is done by detecting movements with a frequency of 250 Hz, 0.5 Hz-250 Hz or 0.5 Hz-200 Hz. Thus, movements which occur with a relatively low frequency are detected, and the basic frequency of variations in the gas pressure inside said cylinder, which is the same as the combustion engine's engine speed, lies within these intervals, which e.g. may typically be 60 revolutions per minute (1 Hz) for a marine diesel engine and as high as 12 000 revolutions per minute (approximately 200 Hz) for an Otto engine in a motorbike.

According to a second aspect of the invention, the above mentioned objectives are achieved through a device, adapted for diagnosis of performance during a combustion process in a combustion chamber in at least one cylinder in a combustion engine, which device comprises at least one sensor element, adapted to be arranged separately from the cylinder's combustion chamber on a part of a cylinder head belonging to the cylinder or to adjacent parts of the engine, and adapted to detect movements of said cylinder head or of adjacent parts in the engine, which movements were generated in the combustion process, and which also comprises a device adapted, based on the detected movements, to calculate pressure changes arising at the combustion in the combustion chamber, and based on the calculated pressure changes to determine whether the performance differs from the expected performance. The function of such a device and the possibilities it offers is described in the discussion above of the innovative method.

The invention also relates to a computer program, a computer program product, an electronic control device, and a motor vehicle which uses the above.

The invention is not limited to any specific type of combustion engine, but encompasses Otto engines as well as compression ignited engines, nor to any specific fuel, non-exhaustive examples of which may comprise fuel in the form of petrol, ethanol, diesel and gas.

Likewise, the invention comprises combustion engines intended for all types of use, such as in industrial applications, in crushing machines and various types of motor vehicles, wheeled motor vehicles as well as trucks and buses, and boats and crawlers or similar vehicles.

### BRIEF DESCRIPTION OF THE DRAWINGS

Below are descriptions of example embodiments of the invention, with reference to the enclosed drawings, in which:

FIG. 1a is a schematic view illustrating a part of a combustion engine, in which a device according to one embodiment of the invention is arranged,

FIG. 1b shows a possible location of a sensor element,

FIG. 2 is a diagram, which schematically illustrates the gas pressure in a cylinder in a combustion engine as a function of time during a working cycle with and without combustion, respectively,

FIG. 3 is a flow chart showing a method according to an embodiment of the invention, and

FIG. 4 is a diagram of an electronic control device for the implementation of a method according to the invention.

### DETAILED DESCRIPTION OF THE INVENTION

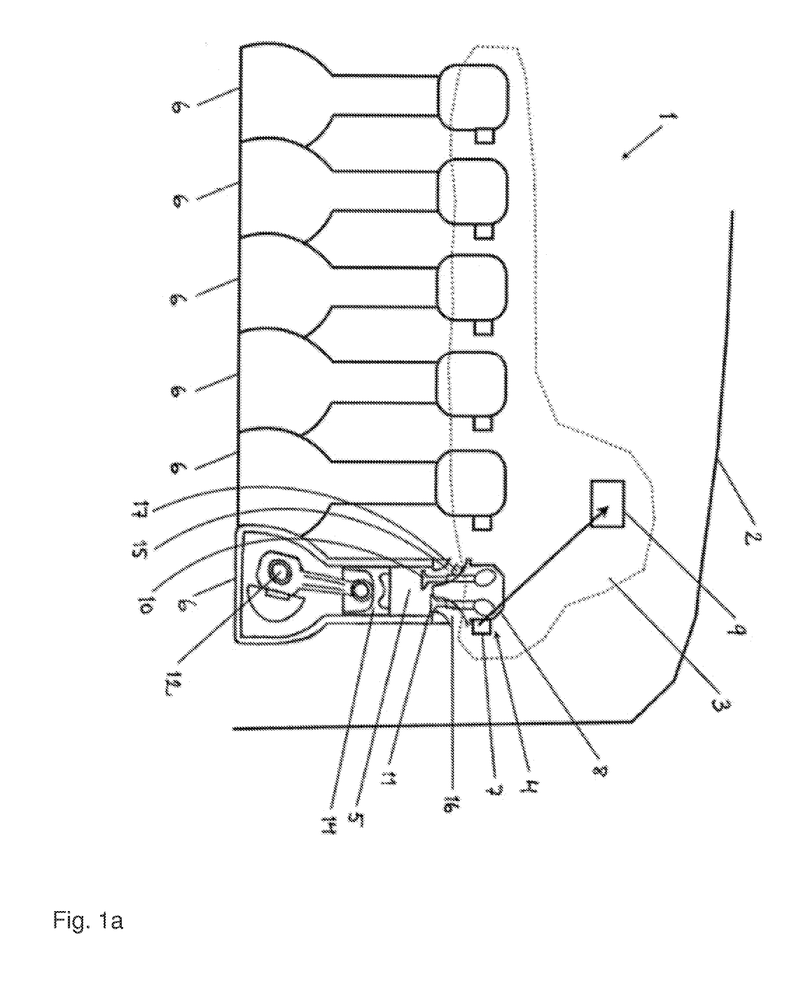

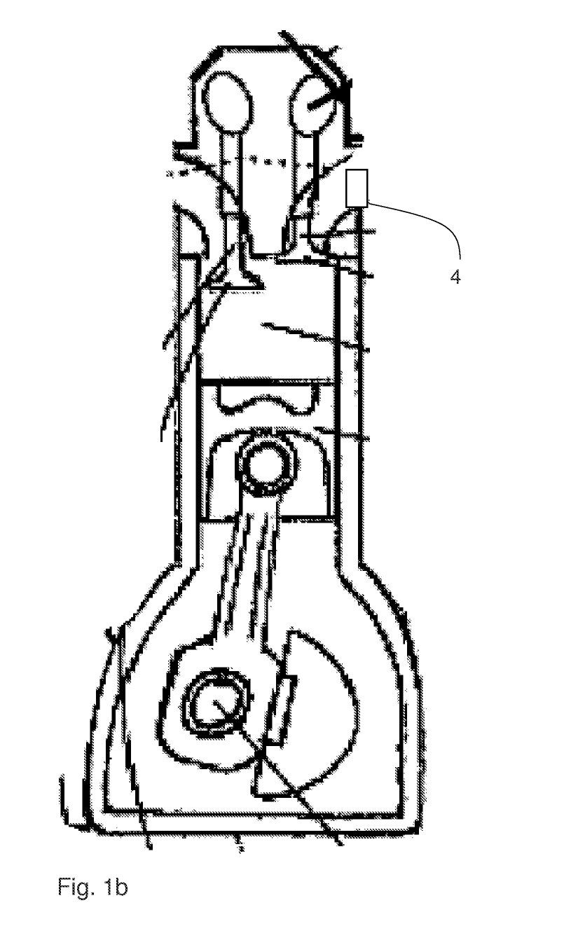

FIG. 1a illustrates very schematically a combustion engine 1, in which a device adapted for diagnosis of the performance during a combustion process in the engine 1 according to one embodiment of the invention, is arranged. The combustion engine is arranged in an implied motor vehicle 2, for example a truck. The engine 1 is equipped with a device 3, indicated with a dashed line, adapted to detect operating conditions in the engine, and such device has a schematically drawn device 4, which is adapted to detect among others the pressure in the combustion chambers 5 of the combustion engine's cylinders 6, of which there are six in this case, but of which there may be any number. Each cylinder 6 comprises a piston 14, arranged to operate a crankshaft 12, an inlet valve 10, which controls the gas in-flow from an inlet channel 15 to the cylinder's combustion chamber 5, and an exhaust valve 11, which controls the outflow of exhausts via an exhaust channel 16. In the inlet channel 15, a pressure sensor 17 is arranged. A pressure sensor (not displayed) may also be arranged inside the exhaust channel 16. An injection element (not displayed) is arranged for injection of fuel into the combustion chamber 5.

The device 4 has, in order to be able to detect said pressures in the combustion chambers 5, one sensor element 7 per cylinder 6, and this is arranged separately from the associated combustion chamber 5 on the respective cylinder's cylinder head 8. The sensor element 7 in this case consists of piezo resistive sensors, adapted to detect movements propagated in the cylinder head 8, in the form of vibrations, generated by pressure changes in the relevant combustion chambers 5. The sensor element 7 is also adapted to detect movements generated by the piston's 14 movements in the cylinder 6, which movements propagate in the cylinder head 8 and in parts adjacent thereto in the engine.

The device 3 also comprises a unit 9, which may consist of the vehicle's electronic control device, adapted to receive information about the detected movements from the sensor elements 7, and to compare such information or information calculated based on such sensor information, with values stored in relation to the desired operating conditions in the engine.

FIG. 1b shows another placement of the sensor element 7. The sensor element is here placed on a section adjacent to the cylinder head. In this example, the sensor element is placed on the engine, specifically on the engine block. The sensor elements/sensors 7 may be of a suitable type, e.g. piezo resistive or piezo electrical elements or optical sensors. The sensor element may here be placed on the engine, in an area adjacent to the outlet of the exhaust channel from a cylinder. For example on a surface on the engine block next to the outlet, on the engine, of the exhaust channel from a cylinder. The surface where the sensor 7 is placed may be substantially vertical. The sensor may be arranged to detect movements, which are perpendicular to the movements of the piston. The sensor may also be arranged to detect movements, which are perpendicular both in relation to the piston's direction of movement and in relation to the engine's longitudinal direction. In one embodiment, the sensor is located on the engine's long side. The sensor may be arranged to detect movements in a direction, which is perpendicular in relation to the surface on which it is placed.

In another embodiment (not displayed) the sensor element 7 may be placed in a corresponding manner as when placed on the engine at the outlet of the exhaust channel from a, but instead placed in a corresponding location on the engine, at the suction channel's inlet to a cylinder on the engine.

The signal detected by the sensor element 7 may be treated in various ways. For example, the following signal treatment steps may be carried out. First the sensor's electrical signal is entered into a control device/signal treatment device. The signal is filtered with a bandpass filter in order to remove superfluous information which does not belong to the frequency range around which information is required. The signal is evened out by way of filtering, averaging or by being replaced with one or several continuous function(s) with good likeness. Subsequently, the signal is scaled, e.g. with the help of the correlation between pressure and volume at compression. Subsequently, (a) suitable part(s) of the signal is/are transformed to the pressure domain. Supplemental modeling closes gaps in the signal's reliability, in order to form a pressure curve. The thus formed pressure curve is used to calculate different values at engine control. In some embodiments one or several of the steps above may be omitted.

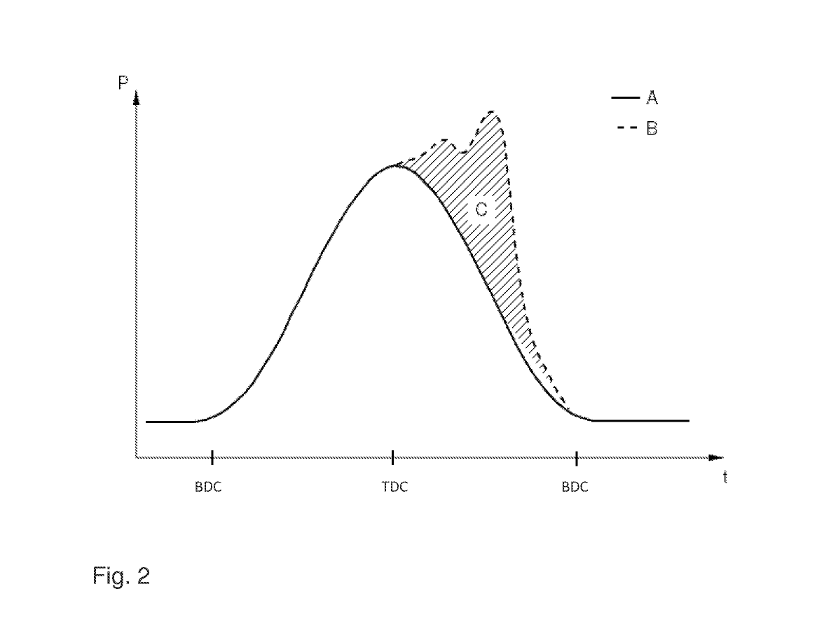

A diagram which schematically illustrates the gas pressure as a function of time in the combustion chamber 5 of the cylinder 6, is displayed at FIG. 2. The solid line A shows the gas pressure during a working cycle without combustion, and the dashed line B shows the gas pressure during a working cycle with combustion. As may be seen in the diagram, the combustion during the expansion stroke of the cylinder 6, that is to say when the piston 14 moves from its top dead center to its bottom dead center with both the exhaust valve 11 and the inlet valve 10 closed, gives rise to pressure changes that differ from the pressure changes arising at a working cycle without combustion. The heat amount released during the combustion may be calculated according to conventional heat release calculation methodology. The diagram shows the released heat amount as the dashed area C.

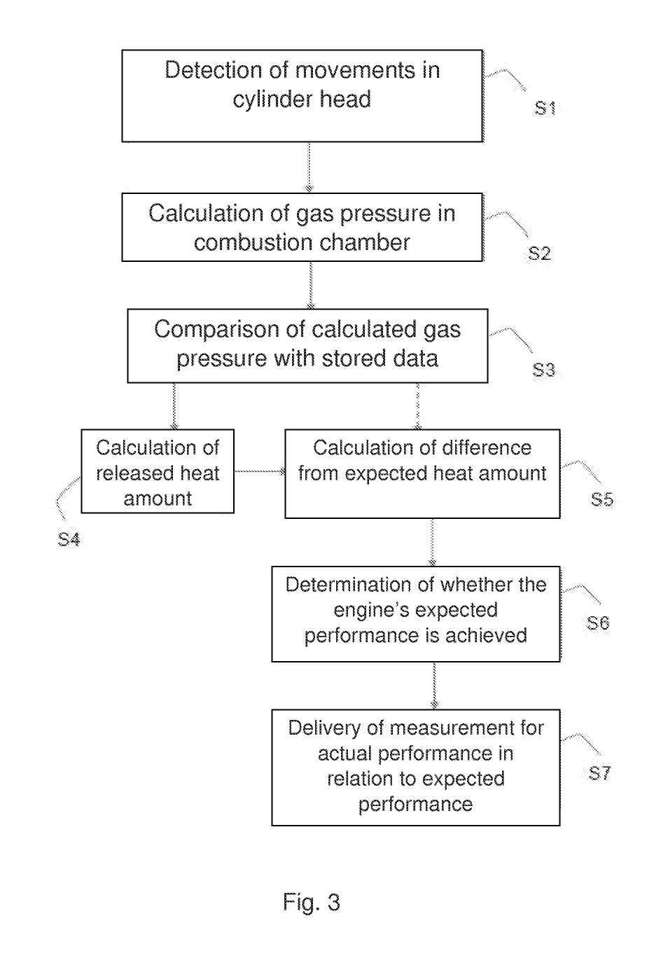

A method according to the invention is carried out when the combustion engine 1 is in operation, and during a working cycle when combustion takes place in at least one of the engine's cylinders 6. One embodiment of the innovative method is schematically illustrated in FIG. 3. In a step S1, which is carried out continuously during operation of the combustion engine, movements are detected which are generated partly by pressure changes in the combustion chamber 5, partly by the pistons 14 as it turns at its top and bottom dead center, respectively, in the cylinder 6. The movements are detected in the cylinder head 8 with the help of the sensor element 7. In step S2 the gas pressure in the combustion chamber 5 is calculated, based on the signal from the sensor element 7 in the unit 9. This step is also carried out continuously during operation. The calculated gas pressure is, in a step S3, compared with stored data relating to a working cycle without combustion in the cylinder 6 in the combustion chamber 5. Based on the comparison, in step S4 the heat amount released during the combustion process, and which may be used as a driving force, is calculated. The released heat amount is compared, in a step S5, with an expected heat amount, wherein the expected heat amount is the amount that may be expected based on the engine's efficiency determined at calibration and an ideal fuel quality. Based on this comparison, in step S6 it is determined whether the engine's performance corresponds to the expected performance. If not, in step S7 a measuring value of actual performance relative to an expected performance is delivered. This measuring value may then be used to control the fuel supply to the cylinder 6 via the injection element.

In an alternative embodiment, the steps S1 and S2 are carried out as above, but in step S3 the calculated gas pressure is compared with stored data relating to an expected gas pressure in the cylinder during the relevant operating conditions. Such data may, for example, be data collected at a calibration of the combustion engine when a fuel with a known heat value was used, such as certification diesel or similar. After step S3, step S5 follows directly, wherein a difference from an expected released heat amount is calculated based on the comparison. Subsequently, the method continues as described above with the steps S6 and S7.

According to a preferred embodiment of the invention, it is determined not only whether the performance differs from the expected performance and the magnitude of such potential difference, but the cause of the performance's divergence is also determined. In this embodiment, the detection of movements which are a result of pressure changes in the combustion chamber 5 of the cylinder 6 is combined with a determination of the crankshaft's 12 position at one or several events associated with the combustion process, such as the start of combustion, the end of combustion, or when 50% of the fuel supplied has been burned. If the crankshaft's position at both the start of combustion and the end of combustion is determined, the duration of the combustion process may also be determined, both in terms of time and crank angle interval. The timing of the start of combustion may be determined with satisfactory accuracy, based on the calculated gas pressure over time, for example by comparing the gas pressure curve at combustion with the corresponding curve in the absence of combustion. The timing is determined by way of a suitable algorithm, such as the point in time when the curves begin to diverge. Similarly, a timing of the end of combustion may be determined as the point in time when the curves converge. The timing of the start of combustion and the end of combustion, respectively, may also be determined by way of detecting a movement with the help of the sensor element 7, resulting from the start of combustion and the end of combustion, respectively. This movement has a higher frequency than the movements caused by the pressure changes in the cylinder 6, and may therefore easily be distinguished from these. The crankshaft's 12 position at said point in time may be determined with the help of a crank angle sensor (not displayed) or by, with the help of the sensor element 7, detecting movements that have been caused by a turn of the piston 14 in the cylinder 6. It is also possible to combine a signal from the crank angle sensor with a signal from the sensor element 7. The crankshaft's 12 position at events associated with the combustion process may also be determined with a method described in the Swedish patent document SE517008, or with a method which is described in the Swedish patent document SE521752, where the sensor element 7 is preferably used to determine the timing of said events.

By comparing the crankshaft's 12 actual, determined position at the start of combustion or another of said events with an expected, optimized position, it is possible to determine whether a divergence in performance is due to poor quality of the fuel, that is to say that the fuel's heat value is too low, or to the fuel being injected at the wrong time into the combustion chamber, which leads to a non-optimal combustion process and too low an efficiency of the engine. If it is determined, for example, that the cause of the low performance is that the crankshaft 12, and therefore the piston 14, is in the wrong position at the start of combustion, information about the position's divergence from an optimal position may be used to control the injection of fuel to a more suitable point in time, when the crankshaft 12 is in an optimal position. If instead it is determined that the cause of the low performance is due to the poor quality of the fuel, information about the divergence of actually released heat from a predicted released heat amount may be used to control the amount of fuel injected.

A computer program code for the implementation of a method according to the invention is suitably included in a computer program, loadable into the internal memory of a computer, such as the internal memory of an electronic control device of a combustion engine. Such a computer program is suitably provided via a computer program product, comprising a data storage medium readable by an electronic control device, which data storage medium has the computer program stored thereon. Said data storage medium is e.g. an optical data storage medium in the form of a CD-ROM, a DVD, etc., a magnetic data storage medium in the form of a hard disk drive, a diskette, a cassette, etc., or a Flash memory or a ROM, PROM, EPROM or EEPROM type memory.

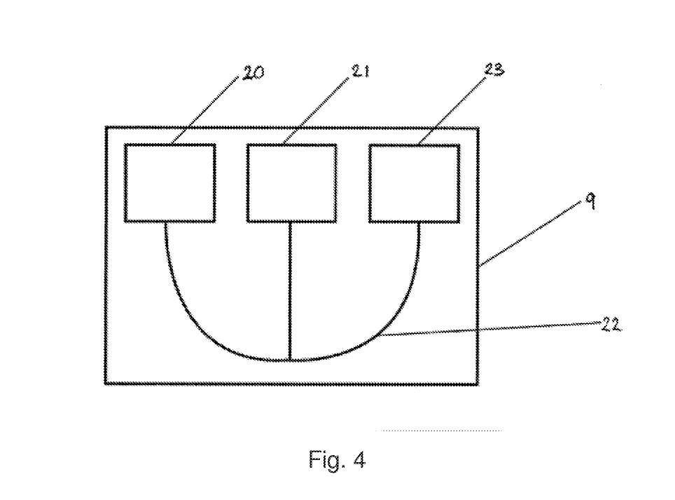

FIG. 4 very schematically illustrates an electronic control device 9 comprising execution means 20, such as a central processor unit (CPU), for the execution of computer software. The execution means 20 communicates with a memory 21, e.g. a RAM memory, via a data bus 22. The control device 9 also comprises a data storage medium 23, e.g. in the form of a Flash memory or a ROM, PROM, EPROM or EEPROM type memory. The execution means 20 communicates with the data storage means 23 via the data bus 22. A computer program comprising computer program code for the implementation of a method according to the invention is stored on the data storage medium 23.

The invention is obviously not limited in any way to the embodiments described above, but numerous possible modifications thereof should be obvious to a person skilled in the area, without such person departing from the spirit of the invention as defined by the appended claims.

1. A method to diagnose the performance of a combustion process in a combustion chamber in at least one cylinder in a combustion engine, wherein the method comprises the steps:
during a working cycle with combustion, detecting movements in a cylinder head belonging to said cylinder (6) or in parts adjacent thereto in the engine generated at pressure changes arising at the combustion in the combustion chamber;
based upon the detected movements, calculating said pressure changes in the combustion chamber; and
based upon the calculated pressure changes, determining whether the actual performance differs from the expected performance.

2. A method according to claim 1, further comprising the step:
comparing the calculated pressure changes with stored data relating to the expected pressure changes for the relevant operating condition, and calculating a divergence from these, so that it is determined, based on the divergence, whether the actual performance differs from the expected performance.

3. A method according to claim 1, further comprising the steps:
comparing the calculated pressure changes with stored data relating to pressure changes in the combustion chamber during a working cycle without combustion;
based upon said comparison, calculating a heat amount released at the combustion;
comparing the released heat amount with an expected released heat amount, and calculating a divergence from this; and
so that it is determined, based on the divergence, whether the actual performance differs from the expected performance.

4. A method according to claim 2, further comprising, based on a said divergence, delivering a measuring value of the actual performance relative to the expected performance.

5. A method according to claim 1, further comprising the steps:
setting at least one first error criterion; and
determining that the actual performance differs from the expected performance, provided that at least the first error criterion is met.

6. A method according to claim 1, further comprising determining a timing for start of fuel supply to the combustion chamber and a timing for start of combustion.

7. A method according to claim 1, wherein the combustion engine comprises a crankshaft, arranged to be operated with said combustion process via a piston, wherein said method further comprises the steps:
determining the position of the crank shaft at a point in time for at least one event associated with the combustion process, such as start of combustion, end of combustion and/or 50% of burned fuel;
comparing the crankshaft's determined position at said event with stored data relating to an expected position of the crankshaft at said event; and
based on the comparison, determining a cause of the divergence between the actual performance and the expected performance.

8. A method according to claim 7, further comprising the steps:
setting a second error criterion, in such a manner that it is met, if the difference between the crankshaft's said determined position and the crankshaft's said expected position exceeds a determined value; and
provided that the second error criterion is not met, determining that a divergence in performance is due to a heat value of the fuel burned during the combustion process not corresponding with an expected heat value.

9. A method according to claim 7, wherein the crankshaft's position is determined by way of detecting movements in the cylinder head or in the parts adjacent thereto in the engine, generated by the piston's movements in the cylinder.

10. A method according to claim 6, wherein the timing of at least one event associated with the combustion process, such as the start of combustion, the end of combustion and/or 50% burned fuel, is determined by way of comparing the calculated pressure changes with stored data relating to pressure changes in the combustion chamber at a working cycle without combustion, and determining the timing of said event based upon the comparison.

11. A method according to claim 6, wherein the timing of at least one event associated with the combustion process, such as the start of combustion, the end of combustion and/or 50% of burned fuel, is determined by way of comparing a calculated released heat amount with stored data relating to an expected released heat amount, and determining the timing of said event, based on the comparison.

12. A method according to claim 1, wherein the combustion engine comprises an inlet valve and an exhaust valve, wherein said method further comprises the detecting of opening and/or closing of at least one of the inlet valve and/or the exhaust valve.

13. A method according to claim 1, wherein the detection of the pressure changes takes place by way of detecting movements with a frequency of ≦250 Hz, 0.5 Hz-250 Hz or 0.5 Hz-200 Hz.

14. A method according to claim 1, wherein movements are detected in or on said cylinder head.

15. A method according to claim 1, wherein movements are detected on the engine, in an area adjacent to the outlet of the exhaust channel from a cylinder.

16. A method according to claim 1, wherein the detection if carried out on the engine, in an area adjacent to the inlet of the suction channel to a cylinder.

17. A device adapted for diagnosis of performance during a combustion process in a combustion chamber in at least one cylinder in a combustion engine, said device comprising:
at least one sensor element, adapted to be arranged separately from the combustion chamber of the cylinder, on a part of a cylinder head belonging to the cylinder or on adjacent parts of the engine, and adapted to detect movements of said cylinder head or of adjacent parts in the engine, which movements were generated in the combustion process; and
a device, adapted to calculate pressure changes arising during the combustion in the combustion chamber, based on the detected movements, and to determine whether the performance differs from the expected performance, based on the calculated pressure changes.

18. A device according to claim 17, wherein said sensor element is arranged in or on said cylinder head.

19. A device according to claim 17, wherein said sensor element is placed on the engine, in an area adjacent to the outlet of the exhaust channel from a cylinder.

20. A device according to claim 17, wherein said sensor element is placed on the engine, in an area adjacent to the inlet of the suction channel to a cylinder.

21. A computer program product comprising computer program code stored on a non-transitory computer-readable medium, which is readable by a computer, said computer program product is used for diagnosis of performance during a combustion process in a combustion chamber in at least one cylinder in a combustion engine, said computer program code comprising computer instructions to cause one or more computer processors to perform the operations of:
during a working cycle with combustion, detecting movements in a cylinder head belonging to said cylinder or in parts adjacent thereto in the engine generated at pressure changes arising at the combustion in the combustion chamber;
based upon the detected movements, calculating said pressure changes in the combustion chamber; and
based upon the calculated pressure changes, determining whether the actual performance differs from the expected performance.

22. (canceled)

23. An electronic control device for a combustion engine, comprising:
an execution means;
a non-transitory computer-readable data storage medium connected to the execution means; and
a computer program product comprising computer program code stored on said non-transitory computer-readable medium, which is readable by a computer, said computer program product is used for diagnosis of performance during a combustion process in a combustion chamber in at least one cylinder in a combustion engine, said computer program code comprising computer instructions to cause one or more computer processors to perform the operations of:
during a working cycle with combustion, detecting movements in a cylinder head belonging to said cylinder or in parts adjacent thereto in the engine generated at pressure changes arising at the combustion in the combustion chamber;
based upon the detected movements, calculating said pressure changes in the combustion chamber; and
based upon the calculated pressure changes, determining whether the actual performance differs from the expected performance.

24. A motor vehicle comprising an electronic control device, wherein said electronic control device comprises:
an execution means;
a non-transitory computer-readable data storage medium connected to the execution means;
a computer program product comprising computer program code stored on said non-transitory computer-readable medium, which is readable by a computer, said computer program product is used for diagnosis of performance during a combustion process in a combustion chamber in at least one cylinder in a combustion engine, said computer program code comprising computer instructions to cause one or more computer processors to perform the operations of:
during a working cycle with combustion, detecting movements in a cylinder head belonging to said cylinder or in parts adjacent thereto in the engine generated at pressure changes arising at the combustion in the combustion chamber;
based upon the detected movements, calculating said pressure changes in the combustion chamber; and
based upon the calculated pressure changes, determining whether the actual performance differs from the expected performance.

25. A motor vehicle according to claim 24, wherein the vehicle is a wheeled motor vehicle, or a boat or a crawler.
